(19) United States
(12) Patent Application Publication
(10) Pub. No.: US 2005/0221159 A1
(43) Pub. Date: Oct. 6, 2005

(54) Liquid fuel cell

(75) Inventors: Yasuhiro Harada, Isehara-shi (JP); Norihiro Tomimatsu, Mitaka-shi (JP); Atsushi Sadamoto, Kawasaki-shi (JP); Hiroaki Hirazawa, Inagi-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/090,791

(22) Filed: Mar. 25, 2005

(30) Foreign Application Priority Data
Mar. 31, 2004 (JP) 2004-106159

(51) Int. Cl. H01M 8/04; H01M 8/24

(52) U.S. Cl. 429/38; 429/37

(57) ABSTRACT

A liquid fuel cell includes a cell stack unit containing at least one separator that includes a liquid fuel flow path and an oxidizer flow path, an end separator stacked on an outermost layer of the cell stack unit and having a liquid fuel inlet, a resin-made manifold plate including a fuel supplying manifold joined to the liquid fuel inlet of the end separator, a resin-made fuel throttle member placed in the fuel supplying manifold and including a fuel passing hole of an opening area smaller than an opening area of the fuel supplying manifold, and a liquid fuel supplying member which supplies liquid fuel to the fuel supplying manifold of the resin-made manifold plate.

### CROSS-REFERENCE TO RELATED APPLICATIONS

This application is based upon and claims the benefit of priority from prior Japanese Patent Application No. 2004-106159, filed Mar. 31, 2004, the entire contents of which are incorporated herein by reference.

### BACKGROUND OF THE INVENTION

1. Field of the Invention

The present invention relates to a liquid fuel cell.

2. Description of the Related Art

Fuel cells have a stack structure in which single cells and separators are stacked alternately one on another. Each single cell has such a structure that an electrolytic layer such as an electrolytic plate or a solid polymer electrolytic film is placed between a fuel electrode and an oxidizer electrode, whereas each separator has grooves serving as reaction gas flow paths, on both of the front and rear surfaces.

A single cell of a liquid fuel cell such as a DMFC (direct methanol fuel cell), includes a membrane electrode assembly (MEA). The membrane electrode assembly has such a structure that a fuel electrode (anode) is integrated to one of the surfaces of the polymer electrolytic film and an oxidizer electrode (cathode) is integrated to the other surface of the film. The fuel electrode includes a catalytic layer and carbon paper. The oxidizer electrode includes a catalytic layer and carbon paper.

A separator has a fuel flow path on its main surface side that faces the fuel electrode of the single cell, an air flow path on its main surface side that faces the oxidizer electrode of the single cell, and vertical holes designed to supply or discharge the fuel and oxidizer to or from the flow paths. Such separators and single cells are alternately stacked one on another. On upper and lower surfaces of the stacked material, end separators are stacked respectively. Each of the end separators has piping functions for supplying the fuel and oxidizer. Further, clamping plates are stacked on both surfaces respectively and with clamping member such as clamping screws, the entire stack structure is integrated as one body, thereby obtaining a liquid fuel cell stack. It is alternatively possible here that the end separators are not used but in place, the flow paths are provided directly in the clamping plates.

Recently, the direct methanol fuel cell power generator is suitable as a power source to be built in small-sized electronic devices, and it has merits that charging is not necessary and it operates for a long time, as compared to the secondary batteries. Under these circumstances, there is an urgent demand for reducing the size of the generator device as a whole and increasing its output, in order to make it possible to mount the fuel cell in a small-sized electronic device.

However, with the structure described above, it is difficult to reduce the size of the power generator stack and simplify its structure. Further, as the number of stacks of cells increases, the distribution of the flow of the liquid fuel in the stacking direction becomes worse. More specifically, in the case of a stack structure in which the end separators have piping functions and the clamping structure is provided as a separate unit, the thickness of the end separator section cannot be easily reduced. Further, insulating member must be provided for the clamping plates, which are usually made of a metal. Thus, it is difficult to simplify the stuck structure or reduce the size thereof. Meanwhile, clamping plates with flow paths directly formed therein are generally made of a metal material in order to maintain a certain degree of strength. However, these plates must be surface-treated by, for example, coating, in order for insulation, prevention of the corrosion of the metal on the flow paths, etc. Thus, it is difficult to simplify the structure. Especially, in the case of the direct methanol type fuel cell, the effects of high-concentration carbonate gas in the fuel discharge side and intermediate products generated by the power generating reaction are so strong that there is a great possibility of damaging the treatment such as the coating. Therefore, the reliability is not so high when the cell is used for a long time. When the coating is damaged, short-circuiting may occur within the stack and metal ions may be mixed into the liquid fuel. The internal short-circuiting may cause not only a decrease in the output from the stack, but also abnormal heat generation and breakage of the MEA. On the other hand, if the fuel is contaminated due to the flow-out of metal ions, the performance and lifetime of the MEA may be significantly deteriorated, which must be avoided in the first place.

Furthermore, in the stack structure, as the number of cells is increased, it becomes more easy for air bubbles mixed into the liquid fuel in the fuel-supplying vertical holes to build up at the fuel inlet part of each of the cells stacked. As a result, the distribution of the flow of the liquid fuel in the stacking direction becomes unstable, thereby causing problems such as lowering of the stability of the output and decreasing of the output itself.

Here, it should be noted that Jpn. Pat. Appln. KOKAI Publication No. 2003-163026 discloses a polymer electrolyte type fuel cell that uses fuel gas (hydrogen) in which a gas inlet and a gas outlet are formed by fitting a joint (Swagelock) to an end plate made of a resin material.

### BRIEF SUMMARY OF THE INVENTION

The objection of the present invention is to provide a liquid fuel cell improved output characteristics.

According to the first aspect of the present invention, there is provided a liquid fuel cell comprising:
a cell stack unit containing a plurality of membrane electrode assemblies and at least one separator, the at least one separator placed between the plurality of membrane electrode assemblies and including a liquid fuel flow path and an oxidizer flow path;
an end separator stacked on an outermost layer of the cell stack unit and having a liquid fuel inlet;
a resin-made manifold plate including a fuel supplying manifold joined to the liquid fuel inlet of the end separator;
a resin-made fuel throttle member placed in the fuel supplying manifold and including a fuel passing hole of an opening area smaller than an opening area of the fuel supplying manifold; and
a liquid fuel supplying member which supplies liquid fuel to the fuel supplying manifold of the resin-made manifold plate.

According to the second aspect of the present invention, there is provided a liquid fuel cell comprising:
a first cell stack unit and a second cell stack unit each containing a plurality of membrane electrode assemblies and at least one separator, the at least one separator placed between the plurality of membrane electrode assemblies and including a liquid fuel flow path and an oxidizer flow path;
a first end separator stacked on an outermost layer of the first cell stack unit and having a liquid fuel inlet;
a second end separator stacked on an outermost layer of the second cell stack unit and having a liquid fuel inlet;
a resin-made manifold plate provided between the first end separator and the second end separator and containing a fuel supplying manifold including an opening joined to the liquid fuel inlet of the first end separator and another opening joined to the liquid fuel inlet of the second end separator;
a resin-made fuel throttle member placed in the fuel supplying manifold and including a fuel passing hole of an opening area smaller than an opening area of the fuel supplying manifold; and
a liquid fuel supplying member which supplies liquid fuel to the fuel supplying manifold of the resin-made manifold plate.

### BRIEF DESCRIPTION OF THE SEVERAL VIEWS OF THE DRAWING

FIG. 1 is a cross sectional view schematically showing a stack of a direct methanol fuel cell according to the first embodiment of the present invention;

FIG. 2 is a plan view schematically showing a separator used in the stack shown in FIG. 1, when viewed from a fuel flow path side;

FIG. 3 is a cross sectional view of the separator shown in FIG. 2 taken along the line III-III;

FIG. 4 is a plan view schematically showing the separator shown in FIG. 1, when viewed from an oxidizer flow path side;

FIG. 5 is a plan view schematically showing a lower manifold plate used in the stack shown in FIG. 1;

FIG. 6 is a plan view schematically showing an upper manifold plate used in the stack shown in FIG. 1;

FIG. 7A is a plan view schematically showing a fuel throttle member used in the lower manifold plate shown in FIG. 5;

FIG. 7B is a side view schematically showing a fuel throttle member used in the lower manifold plate shown in FIG. 5;

FIG. 8 is a front view schematically showing a stack of a direct methanol fuel cell according to the second embodiment of the present invention;

FIG. 9 is a side view of the stack shown in FIG. 8 when viewed from the right-hand side;

FIG. 10 is a partial cross sectional view schematically showing a separator used in a direct methanol fuel cell according to the third embodiment of the present invention;

FIG. 11 is a characteristic diagram illustrating the change in voltage along with time of each single cell of the direct methanol fuel cell according to the first embodiment of the present invention;

FIG. 12 is a characteristic diagram illustrating the change in voltage along with time of each single cell of a direct methanol fuel cell according to a comparative example;

FIG. 13 is a characteristic diagram illustrating the change in voltage along with time of each single cell in the case where the direct methanol fuel cell according to the comparative example is placed in a standard direction;

FIG. 14 is a characteristic diagram illustrating the change in voltage along with time of each single cell in the case where the direct methanol fuel cell according to the comparative example is turned by 180 degrees from the standard direction; and

FIG. 15 is a characteristic diagram illustrating the change in voltage along with time of each single cell in the case where the direct methanol fuel cell according to the first embodiment of the present invention is turned by 180 degrees from the standard direction.

### DETAILED DESCRIPTION OF THE INVENTION

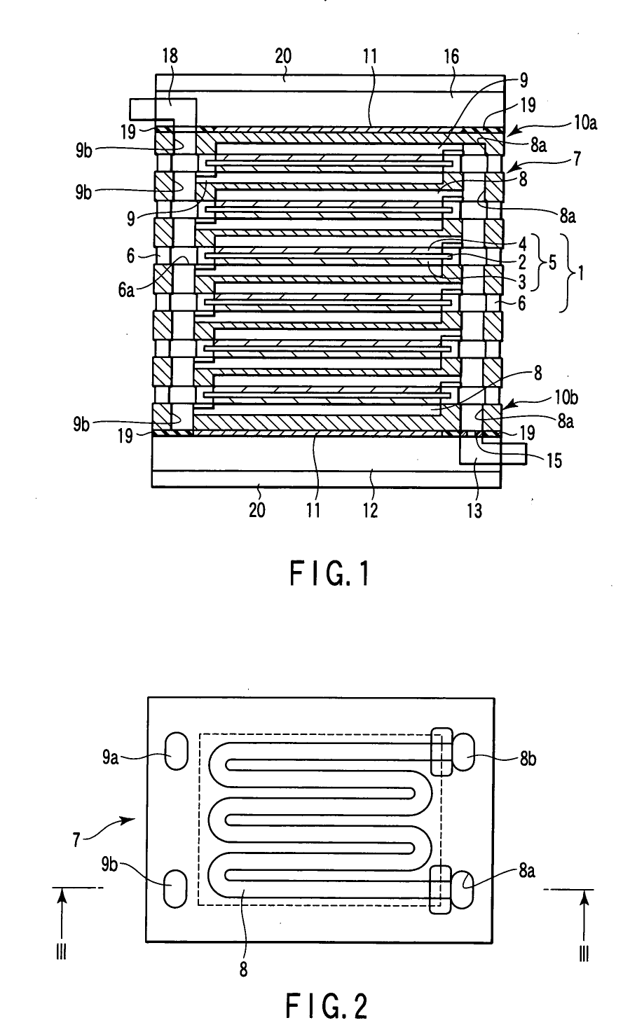

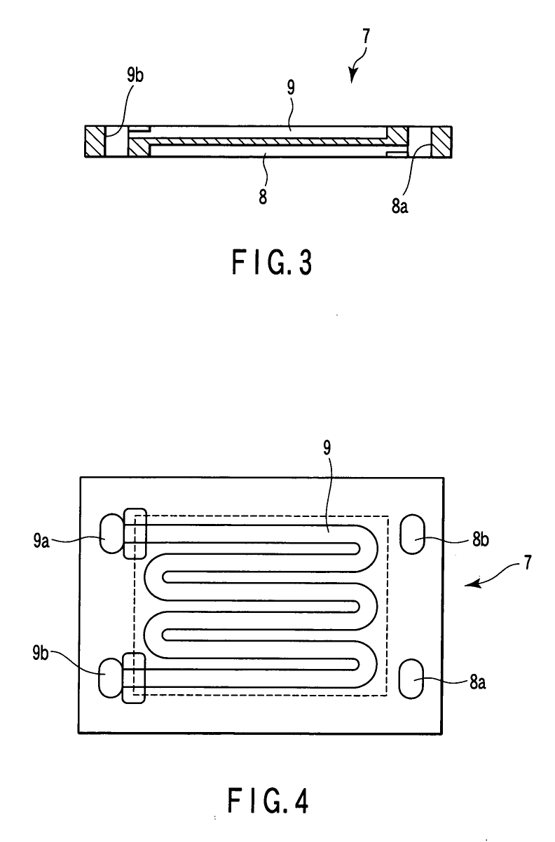

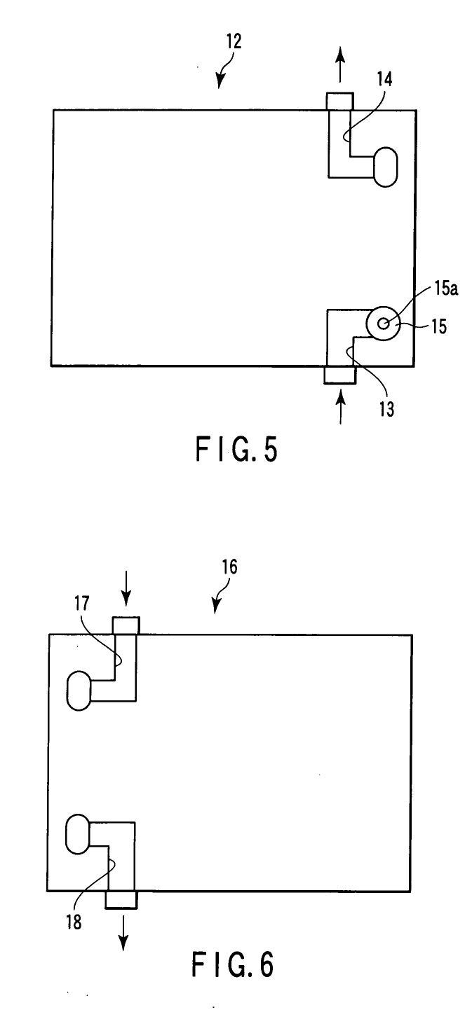

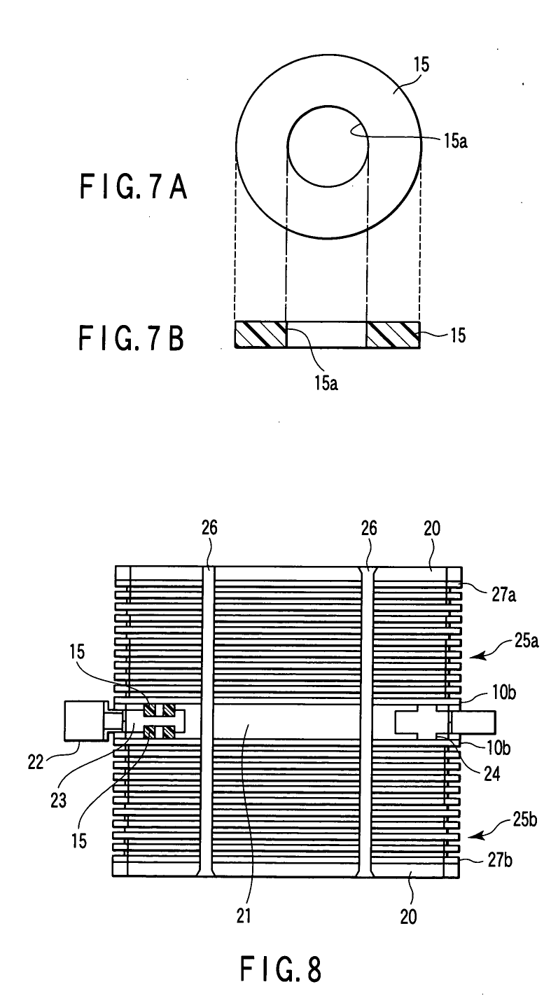

The direct methanol fuel cell (DMFC), which is an embodiment of the liquid fuel cell according to the present invention, will now be described. FIG. 1 is a cross sectional view schematically showing a stack of a direct methanol fuel cell according to the first embodiment of the present invention. FIG. 2 is a plan view schematically showing a separator used in the stack shown in FIG. 1, when viewed from a fuel flow path side. FIG. 3 is a cross sectional view of the separator shown in FIG. 2 taken along the line III-III. FIG. 4 is a plan view schematically showing the separator shown in FIG. 1, when viewed from an oxidizer flow path side. FIG. 5 is a plan view schematically showing a lower end plate used in the stack shown in FIG. 1. FIG. 6 is a plan view schematically showing an upper end plate used in the stack shown in FIG. 1. FIG. 7 includes a plan view 7A and a side view 7B schematically showing a fuel throttle member used in the lower manifold plate shown in FIG. 5.

The stack shown in FIG. 1 contains a cell stack body (cell stack unit) that further contains a plurality of single cells 1. Each single cell 1 includes a membrane electrode assembly (MEA) 5 including a polymer electrolytic membrane 2, a fuel electrode (anode) 3 and an oxidizer electrode (cathode) 4. Each single cell 1 further includes a packing 6 that surrounds the MEA 5. The fuel electrode 3 and oxidizer electrode 4 are integrated respectively to both sides of a polymer electrolytic membrane 2. Each of the fuel electrode 3 and the oxidizer electrode 4 includes a catalytic layer and carbon paper.

The single cells 1 are stacked one on another while interposing a separator 7 between adjacent single cells. Each separator 7 has a meandering fuel path 8 as shown in FIGS. 2 and 3 on its main surface that opposes the fuel electrode 3 of the respective single cell 1. The vertical hole 8a used for supplying the fuel is located at a front right side of the separator in the case of FIG. 2, and the hole is jointed to an inlet of the fuel flow path 8. The vertical hole 8a used for supplying the fuel is also jointed a fuel-supplying vertical hole 8a of another separator 7 stacked to interpose the respective signal cell. An outlet (a rear right side in FIG. 2) of the fuel flow path 8 is jointed to a vertical hole 8b used for discharging the fuel. The vertical hole 8b used for discharging the fuel is also jointed a fuel-discharging hole 8b of another separator 7 stacked to interpose the respective single cell. It should be noted that the fuel-supplying vertical hole 8a and the fuel-discharging vertical hole 8b are independent from an oxidizer flow path 9, which will be described later.

In the opposite main surface of the separator 7, that is, the main surface that opposes the oxidizer electrode 4 of the respective single cell 1, the oxidizer flow path 9 is formed as shown in FIGS. 3 and 4. A vertical hole 9a used for supplying the oxidizer is located at a rear left side of the separator in the case of FIG. 4, and the hole is jointed to an inlet of the oxidizer flow path 9. The vertical hole 9a used for supplying the oxidizer is also jointed an oxidizer-supplying vertical hole 9a of another separator 7 stacked to interpose the respective signal cell. An outlet (a front left side of FIG. 4) of the oxidizer flow path 9 is jointed to a vertical hole 9b used for discharging the oxidizer. The vertical hole 9b used for discharging the oxidizer is also jointed an oxidizer-discharging hole 9b of another separator 7 stacked to interpose the respective signal cell. It should be noted that the oxidizer-supplying vertical hole 9a and the oxidizer-discharging vertical hole 9b are independent from the fuel flow path 8, described above.

The vertical holes 8a, 8b, 9a and 9b of the separator 7 are jointed respectively to vertical holes 8a, 8b, 9a and 9b of the next separator 7 via a vertical hole 6a of an adjacent packing 6. With this structure, four parallel vertical holes are formed in the cell stack body in its stacking direction, and each hole serves as a supplying pipe to a flow path or a discharging pipe from a flow path, respectively.

At the uppermost layer of the cell stack body in which single cells 1 are stacked while interposing separators 7 respectively between adjacent cells, the oxidizer electrode 4 is located. Then, an end separator 10a is stacked on the uppermost layer. The end separator 10a has the same structure as that of the separators 7 except that the fuel flow path 8 is not provided in the end separator. An oxidizer-supplying vertical hole 9a and oxidizer-discharging vertical hole 9b of the end separator 10 are jointed respectively to the oxidizer-supplying vertical hole 9a and oxidizer-discharging vertical hole 9b of the next separator 7 via the vertical hole 6a of the adjacent packing 6. The oxidizer-supplying vertical hole 9a and oxidizer-discharging vertical hole 9b of the end separator 10a serve to supply and discharge the oxidizer to the oxidizer flow path 9 as well as serve as an inlet for introducing the oxidizer to the cell stack body and an outlet for discharging the oxidizer from the cell stack body.

On the other hand, at the lowermost layer of the cell stack body, the fuel electrode 3 is located. Then, an end separator 10b is stacked on the lowermost layer. The end separator 10b has the same structure as that of the separators 7 except that the oxidizer flow path 9 is not provided in the end separator. An fuel-supplying vertical hole 8a, which serves as a fuel inlet of the end separator 10b, and a fuel-discharging vertical hole 8b are jointed respectively to the fuel-supplying vertical hole 8a and fuel-discharging vertical hole 8b of the next separator 7 via the vertical hole 6a of the adjacent packing 6. The fuel-supplying vertical hole 8a and fuel-discharging vertical hole 8b of the end separator 10b serve to supply and discharge the oxidizer to the fuel flow path 8 as well as serve as an inlet for introducing the fuel to the cell stack body and an outlet for discharging the fuel from the cell stack body.

A resin-made manifold plate 12, which serves as a lower end plate, (to be called lower manifold plate) has a fuel supplying manifold 13 formed at a front right side thereof as shown in FIG. 5 and a fuel discharging manifold 14 formed at a rear right side thereof as shown in FIG. 5. A liquid fuel is supplied to the fuel supplying manifold 13 by liquid fuel supplying member (not shown) including a liquid fuel tank and a pump. The lower manifold plate 12 is stacked on the end separator 10b via a current collecting plate 11 interposed therebetween. The fuel supplying manifold 13 is jointed to the opening of the fuel-supplying vertical hole 8a of the end separator 10b and the fuel discharging manifold 14 is jointed to the opening of the fuel-discharging vertical hole 8b of the end separator 10b. A fuel throttle member 15 is a ring-shaped resin plate as shown in FIGS. 7A and 7B, and has an outer diameter that is the almost same as the inner diameter of the fuel supplying manifold 13. The opening area of a round hole 15a formed at the center of the member is smaller than the opening area of the fuel supplying manifold 13. The fuel throttle member 15 is inserted to a connecting portion between the fuel supplying manifold 13 and the fuel-supplying vertical hole 8a of the end separator 10b. In other words, the fuel throttle member 15 is provided at an outlet section of the fuel supplying manifold 13.

On the other hand, a resin-made manifold plate 16, which serves as an upper end plate, (to be called upper manifold plate) has an oxidizer supplying manifold 17 formed at a rear left side thereof as shown in FIG. 6 and an oxidizer discharging manifold 18 formed at a front left side thereof as shown in FIG. 6. The upper manifold plate is stacked on the end separator 10a via a current collecting plate 11 interposed therebetween. The oxidizer supplying manifold 17 is jointed to the opening of the oxidizer-supplying vertical hole 9a of the end separator 10a and the oxidizer discharging manifold 18 is jointed to the opening of the oxidizer-discharging vertical hole 9b of the end separator 10a.

A sealing material 19 is provided in a gap between the lower manifold plate 12 and the end separator 10b and in a gap between the upper manifold plate 16 and the end separator 10a. With this structure, the air-tightness of the end separators 10a and 10b and the four manifolds 13, 14, 17 and 18 can be assured.

A metal-made clamping plate 20 is placed on an outer side of each of the upper manifold plate 16 and the lower manifold plate 12. The stack made of the above-described elements is clamped with clamping member such as screws, and thus a plurality of single cells are integrated as one unit.

A direct methanol fuel cell that contains the stack described above operates in the following manner. That is, as a methanol-containing aqueous solution contained in the liquid fuel tank is supplied to the fuel-supplying vertical hole 8a of the end separator 10b via the fuel supplying manifold 13 by a pump, the liquid fuel is distributed to the fuel supplying vertical hole 8a of each separator 7. Thus, the liquid fuel is supplied to the fuel flow path 8 of each separator 7 via the fuel supplying vertical hole 8a, and eventually the fuel is supplied to the fuel electrode 3 from the fuel flow path 8. The unused portion of the liquid fuel is sent to the fuel discharging vertical hole 8b from the fuel flow path 8, and then to the fuel discharging manifold 15 from the fuel-discharging vertical hole 8b of the end separator 10b. After that, the unused portion is collected into the liquid fuel tank from the fuel discharging manifold 15. The collected liquid fuel is then subjected to adjustment of concentration as needed, and then supplied again to the fuel supplying manifold 13 from the liquid fuel tank. In this manner, the liquid fuel is re-circulated in the fuel flow path 8.

On the other hand, as the oxidizer, which is in the form similar to air, is supplied to the oxidizer-supplying vertical hole 9a of the end separator 10a via the oxidizer supplying manifold 17, the oxidizer is distributed to the oxidizer supplying vertical hole 9a of each separator 7. Thus, the oxidizer is supplied to the oxidizer flow path 9 of each separator 7 via the oxidizer supplying vertical hole 9a, and eventually the oxidizer is supplied to the oxidizer electrode 4 from the fuel flow path 9. Gas discharged from the oxidizer flow path 9 is discharged to the outside of the stack from the oxidizer discharging vertical hole 9b of the end separator 10a and the oxidizer discharging manifold 18.

In the case of the circulation method described above, in which the unused portion of the liquid fuel is collected and then circulated again to the fuel flow path 8, the temperature of the collected portion of the liquid fuel has been raised due to the heat generating reaction involved in the power generation. Therefore, when the portion is re-circulated, the temperature of the fuel is higher than the room temperature. As a result, air bubbles are easily generated within the fuel supplying vertical hole 8a and the fuel flow path 8. If the air bubbles reside inside the stack, the fuel cannot be equally distributed to the fuel flow path of each separator 7, thereby causing the ununiformity of outputs and decrease in the output. Especially, in the case of a small-sized liquid fuel cell for mobile devices, it is not possible to create an excessive amount of flow due to the limitation of the consumption power of the pump or the like. Therefore, it is difficult to push the bubbles away. Further, even if an excessive flow amount is achieved, the loss of the fuel increases due to crossover, and therefore it is not efficient.

According to the present invention, the resin-made fuel throttle member 15 is placed inside the fuel supplying manifold 13. With this structure, since the opening area of the fuel passing hole 15a of the throttle member 15 is smaller than that of the fuel supplying manifold 13, the flow speed of the liquid fuel supplied from the fuel supplying manifold 13 becomes higher as it is passes through the fuel passing hole 15a of the throttle member 15. Thus, the liquid fuel can be sent to the fuel-supplying vertical hole 8a of the end separator 10b at a high speed, thereby creating a turbulent flow in the vertical hole 8a inside the stack. In this manner, the bubbles generated in the vertical hole 8a inside the stack can be dispersed or made disappear. Therefore, even in such a fuel cell that has a small amount of liquid flow such as a fuel cell for mobile devices, the distribution of the liquid fuel in the stacking direction can be stabilized.

Further, since the fuel can be sent to the fuel supplying vertical hole 8a of each separator 7 at a higher liquid flow speed, the variation in output, which results in how the cell stack unit is arranged, can be suppressed. In other words, even if the direction of the flow of the fuel from the fuel supplying manifold to the separator is opposite to the floating direction of bubbles, a constant output can be obtained. Therefore, even in a liquid fuel cell for mobile devices whose fuel flowing direction varies depending on how they are handled, a stable output can be achieved.

Moreover, the pressure variance in the upper manifold plate side of the fuel flow path is not easily propagated to the fuel supplying manifold 13 and therefore it is not necessary to send a certain flow amount of the fuel to the fuel supplying manifold 13 against the pressure variation. In this manner, the pump performance required for a small-sized liquid fuel cell can be lowered. As a result, the structure of the fuel cell power generating device can be simplified, the production cost can be reduced and the efficiency can be improved (to make it into a further power-saving type).

In the meantime, intermediates such as formic acid and formaldehyde that are created in a side reaction during power generation can easily enter the liquid fuel during the re-circulation of the liquid fuel although the amounts of these intermediates are very small. The fuel supplying manifold 13, the fuel throttle member 15 and the fuel discharging manifold 14 are made of a resin, and therefore the corrosion due to these byproducts can be suppressed. Therefore, the amount of conveying the fuel can be maintained at constant for a long period of time, and thus a stable output can be supplied for a long period of time.

Examples of the resin material for forming the upper and lower manifold plates 12 and 16, and the fuel throttle member 15 are polymer resins such as polyacetal, polyethyleneterephthalate, polyethylene, polycarbonate, polyphenylenesulfide, polybutyleneterephthalate, polypropylene, polymethylpentene, denatured polyphenyleneether, syndiotactic polystyrene, polysulphone, polyethersulphone, polyphthalamide, polycyclohexylenedimethyleneterephthalate, polyarylate, polyetherimide, polyetheretherketone, polyimide, fluorine-based resin and silicon-based resin. It is possible that two or more of these resin materials are used to form each of these members.

The shape of the fuel passing hole 15a of the fuel throttle member 15 is not limited to a circular shown in FIGS. 7A and 7B, but it may be of various shapes including rectangular, triangular, elliptic and polygonal.

It suffices if the opening area of the fuel passing hole 15a of the fuel throttle member 15 is smaller than the opening area of the fuel supplying manifold 13; however in order to obtain a sufficient effect, the opening area of the hole should be about 10 to 50% of the opening area of the fuel supplying manifold 13.

Further, the fuel throttle member 15 may be located at anywhere as long as it is inside the fuel supplying manifold 13; however in order to obtain a sufficient effect, the throttle member should be placed at the connecting portion between the fuel supplying manifold 13 and the end separator 10b.

Furthermore, the fuel throttle member 15 may be formed to be integrated with the fuel supplying manifold 13.

The advantages of the first embodiment of the present invention are not limited to those mentioned above, but also the following effects can be obtained.

1) The clamping effect by the upper manifold plate and lower manifold plate can be expected, and thus the thickness of the metal-made clamping plates can be reduced. Therefore, the weight of the liquid fuel cell can be reduced.

2) The processing of the manifolds is easy, thereby making it possible to lower the production cost.

3) With use of the metal-made clamping plates, it is more advantageous in terms of fixation of the fuel cell and processing of the fuel cell, etc. as compared to those which do not use a metal-made clamping plate.

4) With the upper and lower manifold plates, it is possible to insulate the metal-made clamping plate and the cell stack unit from each other. Further, the metal-made clamping plates are provided while interposing the manifold plates respectively between the plates and the cell stack unit. With this arrangement, it is possible to avoid the attachment of the fuel and oxidizer to the metal-made clamping plates. Therefore, there is no need to prepare a separate insulating member or carry out an anti-corrosion coating process to the metal clamping plates.

5) The manifolds can contribute to the reduction in size of the power generating system as the piping is provided at an advantageous position when installing the fuel cell to the system. Further, it is alternatively possible to expand the manifold section to mount auxiliary devices such as the pump and cooling device directly thereon, the piping within the system, which tends to be complex, can be simplified.

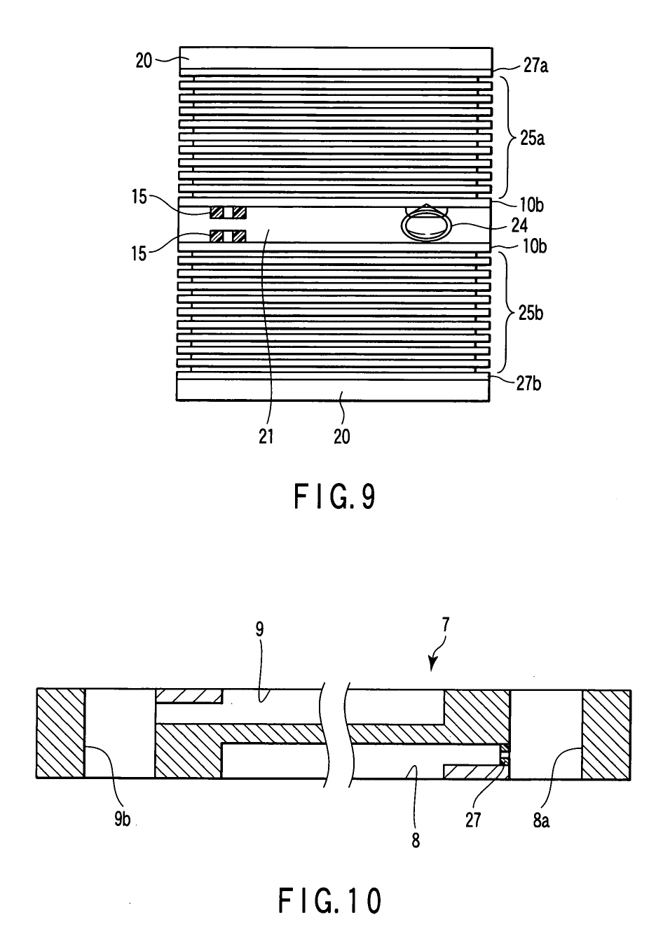

FIG. 1 illustrates an example in which the manifold plates are used as end plates; however the present invention is not limited to this example, but it is also possible to, for example, provide a manifold in an intermediate layer of the stack. With this structure, the system can be further reduced in thickness. An embodiment of such a structure is shown in FIGS. 8 and 9. FIG. 8 is a front view schematically showing the stack used in the second embodiment of the present invention, and FIG. 9 is a side view of the stack shown in FIG. 8 when viewed from the right-hand side.

As shown in FIG. 8, a resin-made manifold plate 21 has a fuel supplying manifold 23 including a fuel supplying joint 22, formed at a front left side of FIG. 8, and a fuel discharging manifold 24 formed at a rear right side of FIG. 8. Further, an oxidizer supplying manifold (not shown) is formed at a front right side of FIG. 8, and an oxidizer discharging manifold (not shown) is formed at a rear left side of FIG. 8. First and second cell stack units 25a and 25b are stacked respectively on upper and lower sides of the resin-made manifold plate 21 to be divided from each other via the plate. With this structure, the fuel and oxidizer are supplied to the first and second cell stack units 25a and 25b from the resin-made manifold plate 21, and the fuel and oxidizer are discharged from the first and second cell stack units 25a and 25b to the resin-made manifold plate 21.

That is, each of the first and second cell stack units 25a and 25 includes a plurality of single cells each further including an anode and a cathode, and at least one separator provided between these single cells and including a liquid fuel flow path and an oxidizer flow path. It should be noted that each of the single cells has a structure similar to that shown in FIG. 1 described before. Also, the separator has a structure similar to that shown in FIGS. 2 to 4 described above. The first end separator 10b having a fuel supplying vertical hole serving as a fuel supplying opening is stacked on an outermost layer (the lowermost layer in FIGS. 8 and 9) of the first cell stack unit 25a. The second end separator 10b having a fuel supplying vertical hole is stacked on an outermost layer (the uppermost layer in FIGS. 8 and 9) of the second cell stack unit 25b.

The resin-made manifold plate 21 is provided between the first end separator 10b and the second end separator 10b. The fuel supplying vertical hole of the first end separator 10b is jointed to one of the opening ends of the fuel supplying manifold 23 of the resin-made manifold plate 21, whereas the fuel supplying vertical hole of the second end separator 10b is jointed to the other one of the opening ends of the fuel supplying manifold 23.

The first and second throttle members 15 are provided respectively at the opening ends of the fuel supplying manifold 23. The first and second end plates 27a and 27b are of such a type that has no flow path opening. The first end plate 27a is placed on the outermost layer of the first cell stack unit 25a, which is on an opposite side to the resin-made manifold plate 21. The second end plate 27b is placed on the outermost layer of the second cell stack unit 25b, which is on an opposite side to the resin-made manifold plate 21. Two metal clamping plates 20 are stacked on the first end plate 27a and the second end plate 27b, respectively. The thus obtained stack is fixed with use of screws 26. The just-described assembling method requires only one resin-made manifold plate, thereby making it possible to further reduce the thickness of the stack.

The first and second embodiments described above are described in connection with the case where the fuel throttle member is provided only for the fuel supplying manifold. However, if another fuel throttle member 27 (to be called separator fuel throttle member 27 hereinafter) is provided at the entrance of the fuel low path 8 of the separator 7 as shown in FIG. 10, the supply of the fuel can be further stabilized. The separator fuel throttle member 27 used here may be of a structure similar to the fuel throttle member of the first embodiment described above. It should be noted that the opening area of the fuel passing hole is defined with reference to not the opening area of the fuel supplying manifold, but the flow path area at the entrance of the fuel flow path of the separator as set to 100%. Further, the separator fuel throttle member may be formed to be integrated with the fuel flow path by cutting the fuel flow path of the separator.

The stack of a direct methanol fuel cell in which a plurality of single cells are stacked in multiple levels should preferably have such a structure that the fuel is evenly supplied to the separators. As the power is generated in the stack, gases including carbon dioxide are generated at the fuel electrode (anode) in each single cell, whereas water is generated at the oxidizer electrode (cathode). As a matter of fact, the power generation is not evenly performed in each of the stacked cells, and the “flow” of the liquid and gases varies along with time from one single cell to another. Especially, the water and gases generated by the power generation cause fluctuation in the inner pressure of the vicinity of the exit of the fuel flow path. Consequently, the pressure variation affects even in the vicinity of the entrance of the fuel flow path. Thus, “cells to which the fuel can easily enter” and “cells to which the fuel cannot easily enter” are created in random time sequence, thereby creating large difference in the voltage and output between the cells. As a result, the output of the stack is lowered.

As a solution to this, the fuel throttle member is provided at the entrance of the fuel flow path of the separator and the pressure loss at the entrance is intentionally increased. Thus, since the pressure loss, which is larger than the pressure variation of the later stages of the flow path, is created intentionally at the entrance, it becomes less likely to be affected by the pressure of the later stages of the flow path. As a result, the pressure loss of the flow path is slightly increased, but it becomes possible to achieve a stable distribution to the stacked cells at a low flow amount. On the other hand, the throttle member makes the entrance of the fuel flow path to be narrowed, and therefore bubbles and the like in the liquid fuel can easily reside at the throttle member. As a solution, the present invention provides the throttle member for the fuel supplying manifold to lessen the bubbles in the liquid fuel, and thus the above-described problem can be avoided.

Therefore, by providing a fuel throttle member to both of the fuel flow path of the separator and the fuel supplying manifold, the flow of the liquid fuel along the stacking direction can be most smoothed when the fuel is supplied at a low flow rate.

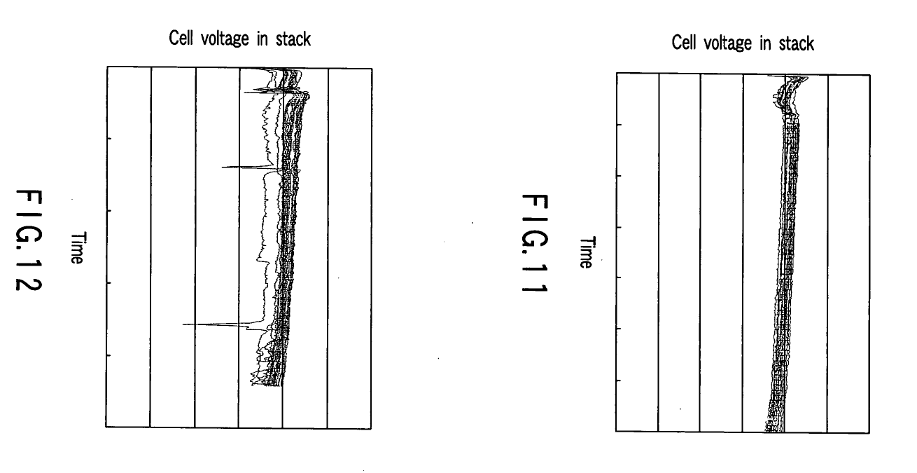

FIGS. 11 and 12 are characteristic diagrams illustrating the change in voltage along with time of each MEA of the direct methanol fuel cell according to the first embodiment of the present invention in which the fuel throttle member is provided, and a direct methanol fuel cell in which the fuel throttle member is not provided (comparative example), respectively. It should be noted that the fuel supplying speed was set with reference to a necessary flow amount in the fuel cell of the comparative example to obtain an even distribution of flow, that is, YmL/min, and it was set to 0.6 times as the flow amount, (that is, Y×0.6 mL/min). Further, the opening area of the fuel passing hole of the fuel throttle member in the fuel cell of the first embodiment was set to 40% of the opening area of the fuel manifold.

As is clear from FIG. 11, the fuel cell of the first embodiment exhibited smooth flow of the fuel and the voltage generated by each of the MEA was stabilized. Thus, each cell (MEA) voltage was enhanced and therefore the output of each cell (MEA) was enhanced.

By contrast, in the comparative example shown in FIG. 12, the voltages of the MEAs were not uniform, and an abrupt drop in volume due to clogging in the fuel by the bubbles was observed.

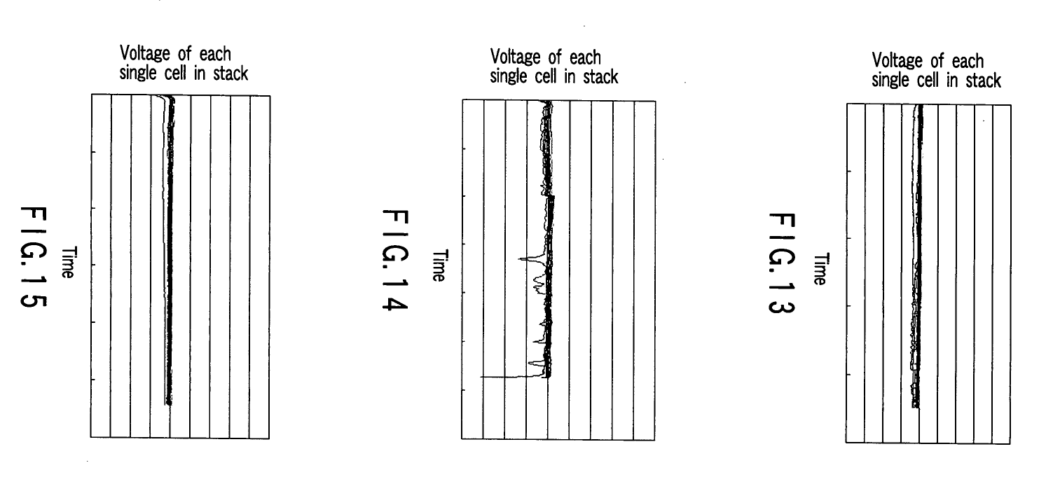

In the meantime, a drawback innate to the liquid fuel type cell is the dependency on the stack placing direction. Especially, in the case of a DMFC that uses a circulating liquid fuel, the fuel temperature is higher than the room temperature as described before, and therefore bubbles are easily generated in the fuel. The flowing direction of the bubbles is dependent on the gravity and therefore the fuel flow direction influences the flow distribution inside the stack. FIGS. 13 and 14 are characteristic diagrams illustrating the change in voltage along with time of each MEA in the case where the liquid fuel is supplied from a standard position of the cell stack unit in the direct methanol fuel cell according to the comparative example in which the fuel throttle is not provided, and in the case where the direct methanol fuel cell is turned by 180 degrees from the standard position (that is, turned upside down), in comparison. As is clear from FIG. 14, when the cell stack unit is turned upside down from the standard position, the dispersion of the cell voltage is observed many more times as compared to the case of the cell stack unit placed at the standard position shown in FIG. 13. These figures correspond to a case where the liquid fuel flowed along the floating direction of the bubbles that were generated in the fuel supplying vertical hole in the cell stack unit (that is, the standard position) and another case where the liquid fuel flowed in the direction against the buoyant force of the bubbles (that is, turned upside down). Since bubbles resided in the flow path due to the gravitational effect, there was ununiformity of cell voltages observed. It should be noted that the test was carried out under such a condition that the influence of the water generated at the cathode resided in the flow path due to the gravitational effect was removed.

By contrast, FIG. 15 shows each MEA voltage of the cell stack unit turned upside down in the direct methanol fuel cell according to the first embodiment of the present invention in which the fuel throttle member was provided. In this figure, such ununiformity of the cell voltages due to the residing bubbles due to the gravitational effect as observed in FIG. 14 was not found. Therefore, it can be understood that in the present invention, even if the direction of the flow of the fuel supplied from the fuel supplying manifold to the separator is opposite to the floating direction of bubbles, the fuel can smoothly flow through the vertical hole.

These phenomena are unique to the fuel cells that use liquid fuels, and a PEM type fuel cell as disclosed in Jpn. Pat. Appln. KOKAI Publication No. 2003-163026 mentioned before, which uses a gas such as hydrogen gas as the fuel, does not entail such a problem. Thus, although this document discusses a fuel cell that utilizes the same resin material, the contents of the technique is different from those of the present invention, which provides a solution to the problem unique to the liquid fuel.

On the other hand, there has been a prior art technique in the liquid fuel-type cells, which uses a resin material in order for the anti-corrosive effect of the structural members. However, the present invention is directed mainly to the solution for problems that run counter to each other, that is, “the reduction of flow amount (power saving) and the stabilization of the fuel flow inside the cell stack unit”.

As described above, according to an embodiment of the present invention, there can be provided a liquid fuel cell in which the liquid fuel flow along the stacking direction is smooth, thereby exhibiting excellent output characteristics.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A liquid fuel cell comprising:
a cell stack unit containing a plurality of membrane electrode assemblies and at least one separator, the at least one separator placed between the plurality of membrane electrode assemblies and including a liquid fuel flow path and an oxidizer flow path;
an end separator stacked on an outermost layer of the cell stack unit and having a liquid fuel inlet;
a resin-made manifold plate including a fuel supplying manifold joined to the liquid fuel inlet of the end separator;
a resin-made fuel throttle member placed in the fuel supplying manifold and including a fuel passing hole of an opening area smaller than an opening area of the fuel supplying manifold; and
a liquid fuel supplying member which supplies liquid fuel to the fuel supplying manifold of the resin-made manifold plate.

2. The liquid fuel cell according claim 1, wherein each of the manifold plate and the fuel throttle member is made of at least one type of polymer resin selected from the group consisting of polyacetal, polyethyleneterephthalate, polyethylene, polycarbonate, polyphenylenesulfide, polybutyleneterephthalate, polypropylene, polymethylpentene, denatured polyphenyleneether, syndiotactic polystyrene, polysulphone, polyethersulphone, polyphthalamide, polycyclohexylenedimethyleneterephthalate, polyarylate, polyetherimide, polyetheretherketone, polyimide, fluorine-based resin and silicon-based resin.

3. The liquid fuel cell according claim 1, wherein the opening area of the fuel passing hole is in a range of 10% to 50% of the opening area of the fuel supplying manifold.

4. The liquid fuel cell according claim 1, wherein the fuel throttle member is provided at an exit section of the fuel supplying manifold.

5. The liquid fuel cell according claim 1, further comprising a resin-made separator fuel throttle member, wherein the resin-made separator fuel throttle member is provided at an entrance of the liquid fuel flow path of at least one separator, and has a fuel passing hole an opening area of which is smaller than a cross sectional area of the flow path at the entrance.

6. The liquid fuel cell according claim 1, wherein the at least one separator has a fuel supplying vertical hole communicating to the liquid fuel flow path and the liquid fuel inlet of the end separator.

7. The liquid fuel cell according claim 1, further comprising: an end separator stacked on an outermost layer of the cell stack unit that is located on an opposite side to the other outermost layer and having an oxidizer inlet; and a resin-made manifold plate including an oxidizer supplying manifold joined to the oxidizer inlet of the end separator.

8. The liquid fuel cell according claim 1, further comprising:
an end separator stacked on an outermost layer of the cell stack unit that is located on an opposite side to the other outermost layer and having an oxidizer inlet;
a resin-made manifold plate including an oxidizer supplying manifold joined to the oxidizer inlet of the end separator;
a metal-made clamping plate stacked on the resin-made manifold plate having the oxidizer supplying manifold; and
a metal-made clamping plate stacked on the resin-made manifold plate having the fuel supplying manifold.

9. The liquid fuel cell according claim 1, wherein the liquid fuel contains methanol.

10. A liquid fuel cell comprising:
a first cell stack unit and a second cell stack unit each containing a plurality of membrane electrode assemblies and at least one separator, the at least one separator placed between the plurality of membrane electrode assemblies and including a liquid fuel flow path and an oxidizer flow path;
a first end separator stacked on an outermost layer of the first cell stack unit and having a liquid fuel inlet;
a second end separator stacked on an outermost layer of the second cell stack unit and having a liquid fuel inlet;
a resin-made manifold plate provided between the first end separator and the second end separator and containing a fuel supplying manifold including an opening joined to the liquid fuel inlet of the first end separator and another opening joined to the liquid fuel inlet of the second end separator;
a resin-made fuel throttle member placed in the fuel supplying manifold and including a fuel passing hole of an opening area smaller than an opening area of the fuel supplying manifold; and
a liquid fuel supplying member which supplies liquid fuel to the fuel supplying manifold of the resin-made manifold plate.

11. The liquid fuel cell according claim 10, wherein each of the manifold plate and the fuel throttle member is made of at least one type of polymer resin selected from the group consisting of polyacetal, polyethyleneterephthalate, polyethylene, polycarbonate, polyphenylenesulfide, polybutyleneterephthalate, polypropylene, polymethylpentene, denatured polyphenyleneether, syndiotactic polystyrene, polysulphone, polyethersulphone, polyphthalamide, polycyclohexylenedimethyleneterephthalate, polyarylate, polyetherimide, polyetheretherketone, polyimide, fluorine-based resin and silicon-based resin.

12. The liquid fuel cell according claim 10, wherein the opening area of the fuel passing hole is in a range of 10% to 50% of the opening area of the fuel supplying manifold.

13. The liquid fuel cell according claim 10, wherein the fuel throttle member comprises a first fuel throttle member provided at the opening, and a second fuel throttle member provided at said another opening.

14. The liquid fuel cell according claim 10, wherein the first cell stack unit and the second cell stack unit each further comprises a resin-made separator fuel throttle member, wherein the resin-made separator fuel throttle member is provided at an entrance of the liquid fuel flow path of at least one separator, and has a fuel passing hole an opening area of which is smaller than a cross sectional area of the flow path at the entrance.

15. The liquid fuel cell according claim 10, wherein the liquid fuel contains methanol.
